(19) United States
(12) Patent Application Publication
(10) Pub. No.: US 2025/0007632 A1
(43) Pub. Date: Jan. 2, 2025

(54) DATA TRANSMISSION METHODS, COMMUNICATION DEVICES AND ASSOCIATED SYSTEM

(71) Applicant: SAGEMCOM ENERGY & TELECOM SAS, Bois-Colombes (FR)

(72) Inventors: Henri TEBOULLE, Bois-Colombes (FR); Ziv ROTER, Bois-Colombes (FR)

(21) Appl. No.: 18/750,931

(22) Filed: Jun. 21, 2024

(30) Foreign Application Priority Data
Jun. 28, 2023 (FR) 2306795

(51) Int. Cl. H04B 17/373; H04B 17/309

(52) U.S. Cl. CPC H04B 17/373; H04B 17/309

(57) ABSTRACT

A method for data transmission between a data server device and a data-receiving client device is disclosed. The server device comprising a memory and a processor which causes the server device to:
obtain, over a first time period, a plurality of measurements characterizing a quality of transmission between the client device and the server device;
determine, depending on the measurements, information characterizing the evolution over time of a relative level of quality of transmission during the first period;
transmit the information to the client device;
receive, during a second future period with respect to the first period, a data transmission request from the client device, the time of transmission of the request by the client device depending on said information transmitted by the server device to the client device; and
transmit the data to the client device in response to the request.

### CROSS-REFERENCE TO RELATED APPLICATION

The present application claims foreign priority to French Application No. 2306795 filed on Jun. 28, 2023 with the French Patent Office, the entirety of which is incorporated herein by reference.

### TECHNICAL FIELD

The invention discloses data transmission methods, communication devices for respectively transmitting and receiving the data, an associated system and computer program product. The solutions disclosed apply, in a non-limiting way, in the context of a transmission of recurrently collected data.

### TECHNICAL BACKGROUND

In numerous applications, devices accumulate data periodically or non-periodically, requiring a collection, by a receiving client device, of data accumulated by a producing server device. This is for example the case of meters of diverse natures, such as electricity, gas, water or thermal energy meters. Such a device can generate periodic data, for example a value measured repeatedly by the meter over a given period, or even in the case in which various events occur. The data accumulate while waiting for their transmission to the collector client device.

The communication between the server and the client can be done on a network whose transmission conditions can vary. These devices can, for example, be equipped with a 2G to 5G type cellular network interface, subject to interference and with a variable load. In addition, the network may be more or less saturated. Carrying out a transmission under unfavorable conditions may have harmful consequences: the frames sent may not be received correctly, and it may be necessary to make one or more additional attempts to resend certain frames. This contributes not only to a possible saturation of the network, but also to an overconsumption of data by the server device.

There is a need for an effective transmission method taking these aspects into account.

### SUMMARY

One or more embodiments relate to a method for transmitting data between a data server device and a data-receiving client device in a communication network, the server device comprising a memory including software code and a processor which, when it executes the software code, causes the server device to implement the method, the method comprising:
obtaining, over a first time period, a plurality of measurements characterizing a quality of transmission between the client device and the server device;
determining, depending on the measurements, information characterizing the evolution over time of a relative level of quality of transmission during the first period;
transmitting information to the client device;
receiving, during a second future period with respect to the first period, a data transmission request from the client device, the time of transmission of the request by the client device depending on said information transmitted by the server device to the client device; and
transmitting the data to the client device in response to the request.

The server device thus collects information characterizing, over time, a relative level of quality of transmission during a first period, which will allow the client device to implement this information in order to decide on a favorable time to request the data transmission during a future period. In addition, the information characterizes a relative level of quality of transmission during the first period, which makes it possible to characterize the best level of quality to which the server device can aspire.

According to one or more embodiments, the first period being sub-divided into time intervals, determining the information comprises determining a level of quality for each interval on the basis of measurements taken for this interval with respect to one or more thresholds determined from the measurements taken over the entire first period.

According to one or more embodiments, the one or more thresholds are chosen between the highest and the lowest measurement value of the first period.

According to one or more embodiments, the steps of determining the information and transmitting this information are carried out periodically.

According to one or more embodiments, the first period is one among: a time range of a day, a day.

According to one or more embodiments, the method comprises receiving a data transmission request from the client device and transmitting data in response to the request.

One or more embodiments relate to a method for transmitting data between at least one data server device and a data-receiving device in a communication network, the receiving device comprising a memory including software code and a processor which, when it executes the software code, causes the receiving device to implement the method, the method comprising:
receiving, from a given server device, information characterizing an evolution of a relative level of quality of transmission between the client device and said given server device during a first time period;
estimating the relative level of quality of transmission during a given time interval of the second period on the basis of said information corresponding to the same time interval of the first period, the time range covered by the first period including at least the time range of the second period;
deciding to send a data transmission request to the given server device during the given interval depending on the comparison of the estimation for this interval with a quality threshold.

According to one or more embodiments, the sending decision is taken as time advances during the second period, until sending results in successfully receiving said data.

According to one or more embodiments, said quality threshold depends on the placement of the given interval in the second period, the quality threshold having a maximum value at the start of the second period and decreasing as time advances in the second period toward a minimum value.

According to one or more embodiments, the second period is one among
a part of a day corresponding to the same part of the day covered by the first day during a previous day;
the day following a day covered by the second period.

According to one or more embodiments, the method comprises receiving information from a plurality of server devices, the decision to send a request to a server device depending on the information received from this server device.

One or more embodiments relate to a server device comprising a memory including software code and a processor which, when it executes the software code, causes the server device to implement one of the described methods.

One or more embodiments relate to a client device comprising a memory including software code and a processor which, when it executes the software code, causes the client device to implement one of the described methods.

One or more embodiments relate to a system comprising a client device and at least one server device.

According to one or more embodiments, the communication network is a cellular network. One or more embodiments relate to a non-transient storage medium readable by a device provided with a processor, said medium comprising instructions which, when the program is executed by a processor of a device, cause the device to implement at least one of the described methods.

### BRIEF DESCRIPTION OF THE FIGURES

Further features and advantages will become apparent from the following detailed description, which may be understood with reference to the attached drawings in which:

FIG. 1 is a block diagram of a system comprising a server device and a client device according to one or more embodiments;

FIG. 2 is a flowchart of a method implemented by a data server device according to one or more exemplary embodiments;

FIG. 3 is a flowchart of a method corresponding to one step of the method of FIG. 2 according to one or more exemplary embodiments;

FIG. 4 is a flowchart of a method implemented by a data-receiving device, or client device, according to one or more exemplary embodiments.

### DETAILED DESCRIPTION

In the following description, identical, similar or analogous elements will be referred to by the same reference numbers.

The block diagrams, flowcharts and message sequence diagrams in the figures illustrate the architecture, functionalities and operation of systems, devices, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller prompts the system or device to implement all or part of the functionalities of the blocks and/or steps of the processes or methods according to the exemplary embodiments. The software code can be stored in a memory or a readable medium accessible directly or via another module by the processor or controller.

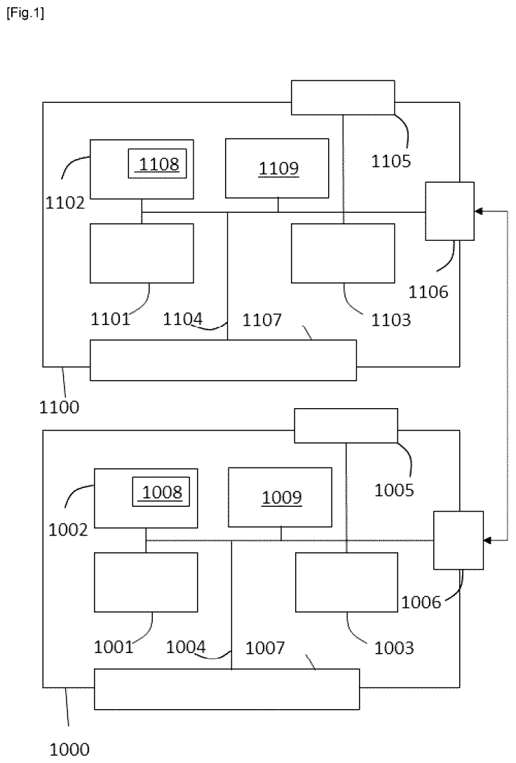

FIG. 1 is a block diagram of a communication network comprising a device 1000 and a device 1100 able to communicate bidirectionally via the network, according to one non-limiting embodiment. The device 1000 is a device that stores accumulated data or itself accumulates data, at least some of which are to be transmitted to the device 1100. Hereafter, the device 1000 will be referred to as the “server” and the device 1100 will be referred to as the “client”. The server device 1000 includes a processor 1001, a memory 1002, a data source 1003, a user interface 1005, a communication interface 1006 configured to communicate bidirectionally with the client device 1100, a display 1007 suitable for displaying data to a user of the server device 1000, as well as a working memory 1009. The various components of the server device 1000 are connected via a communication bus 1004. The memory 1002 includes software code 1008. The memory 1009 is used to store and manage the data to be transmitted. When the processor executes the software code 1008, it causes the server device to implement a method according to one or more exemplary embodiments described. These data come for example from the data source 1003. Similarly, the client device includes a processor 1101, a memory 1102, a mass storage 1103 intended to store the data received from the server or from several servers, a user interface 1105, a communication interface 1106 configured to communicate bidirectionally with the server device 1000, a display 1107, a working memory 1109 and a communication bus 1104. The memory 1102 includes software code 1108. When the processor executes the software code 1108, it causes the client device to implement a method according to one or more exemplary embodiments described.

The devices 1000 and 1100 are described hereinbefore by way of illustration and may include more or fewer functional blocks than those described hereinbefore, according to the requirements of a particular context. Especially, the display may be absent.

For example, the server device 1000 is a metrological meter of a physical quantity (typically a measurement of electricity, water, gas, thermal energy, etc.), while the client device 1100 is a device collecting the data from different servers on behalf of the operator of the distribution network. The data source 1003 is for example the metrological unit per se, of the meter, the unit that produces a value of the quantity being metered. The metrological unit is for example responsible for measuring and recording an absolute physical quantity (intensity of a current, gas pressure) or a cumulative one (electrical energy or volume of a gas that has passed through). The data can be obtained periodically or aperiodically or comprise a combination of data obtained periodically and aperiodically. The communication network is for example a radio medium of one of the types 2G/3G/4G/LTE NB-IoT/LTE Cat-M1/LoRa or other types. DLMS, or “Device Language Message Specification”, comprises a series of standards developed and held by the DLMS User Association (“DLMS UA”) standardizing data exchanges for electricity meters or other meters. The DLMS UA in particular maintains the COSEM (Comprehensive Semantic Model for Energy Management) “Blue Book”. Reference may be made to document “DLMS UA 1000-1”, version 15, part 2, version 1.0 dated Dec. 21, 2021 for more information regarding DLMS.

The server 1000 and the client 1100 of FIG. 1 can, by way of non-limiting example, be compatible with the DLMS standard, but the reference to this standard is substantially made to illustrate a concrete embodiment more clearly, without this limiting the generality of the disclosure. A person skilled in the art will be able to adapt the teachings of the present description to contexts other than DLMS.

According to one or more embodiments, a data transmission from a server device to the client device is performed on the initiative of the client device. The client device transmits a request to a server, the latter then initiating the transmission of its data to the client device. The client and the server then operate in transmission-on-request mode, referred to as “pull” mode.

According to one or more embodiments, a server device determines information characterizing the evolution of a relative level of quality of the transmission conditions between the client device and the server device over time, over a given reference time period. This information depends on quality measurements taken during this period by the server device, and are communicated by the server device to the client device. The latter can then use the information to select the time or times to request a transmission, by the server device, of useful data during a future time period.

The time period during which the client device will use the information is a period for which the evolution of the level of quality is expected to be substantially identical or at least close to that of the reference period. The information characterizing the evolution of a level of quality of the transmission conditions over time is determined on the basis of real measurements in order to obtain a relative level of quality. Indeed, for a given server device, values that the measurements actually reach and not theoretical values that are potentially not reached in practice are taken into account. A same level of quality determined by two separate server devices will therefore be able to indicate different transmission conditions, but for example the best level of quality will indicate for the two servers the best transmission conditions which can be expected.

According to one or more exemplary embodiments, the reference period and the future period are periods at the same times of two separate days, for example a period of 6 hours from the morning to midday. A period may also cover a full day.

The assumption is made that the behavior of the network has, for example over substantially identical time ranges, analogies in the evolution of the level of quality over time. Thus, the information provided by the server device to the client device is a prediction—or even a presumed estimation—of the quality at different times of a future similar period, prediction which the client device uses to choose the appropriate time to request a transmission from a server in order to improve the chances of correctly receiving the data.

According to one or more embodiments, the reference period is defined by the client device. For example, the client device can determine the start time and the duration of a reference period and transmit it to one or more client devices. According to other embodiments, the reference period is fixed.

According to one or more embodiments, the time period during which the client device will seek to collect the data from the server device corresponds to only a part of the reference period. Indeed, the server device can transmit information for a longer reference period than the transmission period envisaged by the client device.

According to one or more exemplary embodiments, the client device can receive information characterizing the evolution of a level of quality over time of several server devices and thus request the transmission of data in a differentiated manner for each server device. Indeed, the specific location of a server device can impact the transmission conditions and the evolution of the network conditions can be specific to each server device. The information determined by each server device can therefore differ.

According to one or more exemplary embodiments, the server device determines information characterizing a level of quality over time on the basis of measurements collected over a single reference period or, according to a variant, on the basis of measurements collected over several reference periods. Thus, it is possible to limit the impact of noisy measurements.

According to one or more exemplary embodiments, determining information characterizing a level of quality over time includes analyzing collected measurements in order to determine one or more thresholds in the range of the values of the collected measurements, for example over a reference period. The information is then determined depending on these thresholds.

According to one or more exemplary embodiments, the period is one day or a part of day. According to one variant, it differs according to the day of the week. For example, information characterizing the level of quality is determined separately for a weekday and for a weekend day. Other distinctions may be made according to local customs (business day or not, Sunday, public holiday, etc.). According to other embodiments, the reference period is taken during a weekday identical to that of the period of transmission by the client device.

According to one or more exemplary embodiments, the information characterizing the level of quality over time is evaluated by the server device over a reference period and used by the client device for the next similar period. For example, the reference period is one day (or a time range of the day) and the period during which the client device uses the information from this reference period is during the next day (or during the same time range of the following day). According to other exemplary embodiments, information determined on the basis of a reference period is used during several similar periods.

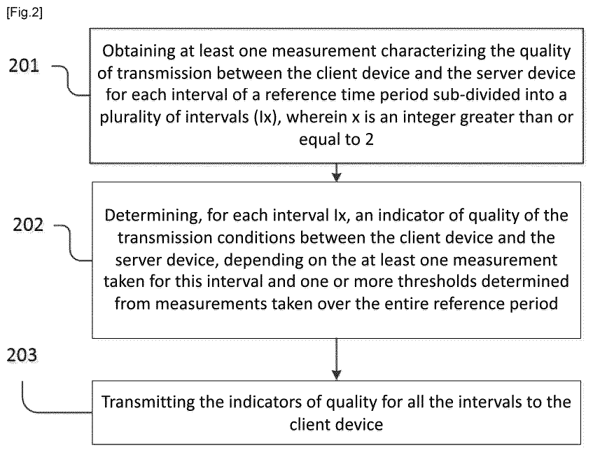

According to one or more exemplary embodiments, the information characterizing the level of quality is determined on the basis of a plurality of measurements taken during the reference period, these measurements characterizing the quality of the transmission (for example, the signal power, the signal-to-noise ratio, etc.). For a 2G cellular network they can be based, for example, on the received signal strength indicator (RSSI). For a 4G, LTE NB-IoT or LTE Cat-M1 network, it is possible to use the reference signal received power (RSRP), or the reference signal received quality (RSRQ), representative of the signal-to-noise ratio. FIG. 2 is a flowchart of a method implemented by a server device, according to one or more non-limiting embodiments. The method comprises:
201—Obtaining at least one measurement characterizing the quality of transmission between the client device and the server device for each interval of a time period P1 sub-divided into a plurality of intervals Ix, wherein x is an integer greater than or equal to 2.
202—Determining, for each interval, a level of quality of the transmission conditions between the client device and the server device, depending on the at least one measurement taken for this interval with respect to at least one quality threshold determined from measurements taken over the entire reference period.
203—Transmitting levels of quality for all the intervals to the client-device.

Determining a level of quality from several measurements makes it possible to maintain the information transmitted to the client device within a contained data volume. According to the method for determining the level of quality depending on the measurements, this also makes it possible to reduce the potential noise in these measurements (the level of quality being able to aggregate, in one way or another, all the measurements associated with one interval), or else to obtain a statistical representation thereof, for example based on percentiles.

The one or more quality thresholds can be defined in various ways. Two examples will now be described.

According to a first embodiment, level of quality is determined from the measurements with respect to one or more preprogrammed thresholds in the server device.

According to one non-limiting example, two thresholds are implemented: a first threshold, referred to as high threshold (Threshold_H) and a second threshold, referred to as low threshold (Threshold_L). Above the high threshold, the quality is deemed to be good; below the low threshold, the quality is deemed to be poor; and between the two thresholds, the quality is deemed to be average. The preprogrammed thresholds may for example have been determined according to the circumstances on the basis of typical values for the network under consideration.

According to a second embodiment, the level of quality is determined from the measurements by training. One or more thresholds are obtained from measurements taken for the entire reference period. This makes it possible especially, as indicated above, to establish the one or more quality thresholds with respect to values actually reached by the measurements.

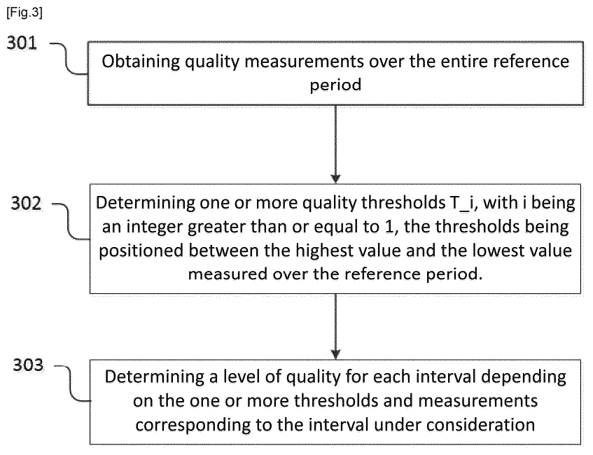

According to one non-limiting example illustrated by the flowchart of FIG. 3, the server device performs a multitude of measurements over the entire reference period in 301.

For example, if the reference period is one day, and it is considered that the quality is measured by virtue of the RSRQ, a measurement can be taken each minute, which will give 1440 RSRQ measurements. It is assumed in what follows that a first measurement value greater than a second measurement value will indicate a better quality than the quality indicated by the second measurement value. A skilled person will know how to adapt the described method if a first value lower than a second value is indicative of better quality than that corresponding to the second value.

Once the measurements have been taken for the reference period, the server determines (302) one or more thresholds T_i, with i being an integer greater than or equal to 1, the thresholds being positioned between the highest value and the lowest value measured over the reference period. A threshold is positioned so that Qi % of the best measurements in terms of quality indicated are above this threshold, with i being an integer greater than or equal to 1 and with Qi being an increasing function of i. This involves processing the measurements by percentiles.

As a numerical example, it was observed that a value of i equal to 2 made it possible to obtain good results in an experimental context. As above, these thresholds are referred to as high threshold (T_H) and low threshold (T_L). Above the high threshold, the quality is deemed to be good; below the low threshold, the quality is deemed to be poor; and between the two thresholds, the quality is deemed to be average. For example, the high threshold may be defined as being a threshold above which 25% of the best values among the measurements taken are found, while the low threshold can be defined as being the threshold above which 75% of the best values are positioned. Of course, the percentages hereinbefore are given by way of illustration and can have different values.

According to one variant of the second embodiment, the one or more thresholds are determined from measurements taken over several periods and not only one.

According to one or more exemplary embodiments, the first embodiment of determining thresholds with preprogrammed value is used while waiting for training according to the second embodiment to be carried out.

Once the one or more thresholds are obtained, for each interval of the reference period, a level of quality is determined (303) depending on the one or more thresholds and measurements corresponding to the interval under consideration.

According to a non-limiting example, N levels of quality are determined, from the poorest quality to the best quality, with N being an integer greater than 2. A level of quality is assigned depending on the distribution of the measurement values with respect to the thresholds.

For example, two thresholds (high threshold T_H, low threshold T_L) are considered, with five levels of quality (for example level +2 representing very good quality and level −2 representing very poor quality), a reference period of one day divided into 96 fifteen-minute intervals, with one quality measurement obtained every minute. One example of assigning one of the five levels of quality Ki for a given interval is as follows:
The sixteen measurements of an interval Ki are considered
1. If 75% (or more) of the measurements are greater than or equal to the high threshold, level +2 is assigned
2. Otherwise, if 50% of the measurements are greater than or equal to the high threshold, level +1 is assigned
3. Otherwise, if 75% of the measurements are less than the low threshold, level −2 is assigned
4. Otherwise, if 50% of the measurements are less than the low threshold, level −1 is assigned
5. Otherwise, level 0 is assigned.

The values hereinbefore are integers centered around zero by way of illustration; other scales may of course be used.

Table 1 is an example of a structure of the useful data included in a frame used for the transmission, by the server device to the client device, of information characterizing the evolution of a level of quality of the transmission conditions over time in the form of levels of quality per time interval, the table containing a level of quality (encoded, according to the example, over three bits) per interval of the reference period (or, according to the example, 96 intervals). The useful data may have a simpler structure, which comprises for example simply a list of values of three bits in chronological order of the intervals in the reference period, the interval to which one value relates being identified implicitly by the order of the values.

TABLE 1

| Interval Ki | 1 | 2 | . . . | n | . . . | 95 | 96 |
|---|---|---|---|---|---|---|---|
| Level of quality | 3 bits | 3 bits | 3 bits | 3 bits | 3 bits | 3 bits | 3 bits |

According to one or more exemplary embodiments, the transmission, from the server device to the client device, of information characterizing the evolution of a level of quality of the transmission conditions over time is carried out at the end of the reference period or prior to or at the very start of the period during which the client device must use it.

According to one or more exemplary embodiments, the client device implements the information characterizing the evolution of a level of quality of the transmission conditions during a reference period received from a given server to determine, during a similar period, the appropriate times for initiating a data transfer from this server.

According to one or more exemplary embodiments, if the client device does not receive the information characterizing the evolution of a level of quality of the transmission conditions over time from a given server device, the client device uses information previously received from this server device.

The period during which the transmission of data by the server device is sub-divided into several sub-periods each covering several contiguous intervals. Taking the sub-periods in chronological order, the client device will search, in one sub-period, whether this period comprises one or more intervals having at least one given quality (for example, one level of quality among N, to return to a non-limiting example already described), by reducing the required level of quality across the sub-periods. If at least one time interval satisfying this criterion is found, the client device will transmit to the server device, at the beginning of each of the found intervals, a message to request the transmission of useful data, until the transmission of the requested data from the server device is correctly performed. If no interval corresponding to the quality criterion is found in one sub-period, then no request to transmit useful data is transmitted to the server device. If there are several corresponding intervals, a request is transmitted interval-by-interval corresponding to the criterion, until the useful data have been correctly received. At the end of one sub-period, the next sub-period starts, with a reduction of the required level of quality.

When the end of the period is reached without a correct transmission of useful data having taken place, the method ends. According to one variant, a new test is carried out during another period.

The progressive reduction of the required level of quality makes it possible initially, at the beginning of the period, to search for the intervals that give the best chances of resulting in a successful transmission of the data. The cost in terms of the amount of data transmitted is thus reduced. In the event of failure, as the period progresses, the requirement is reduced. Worse transmission conditions are then accepted, which may require several transmission attempts in order for the data to be correctly received. This makes it possible, according to the circumstances, to receive the data, but at a higher cost in terms of the amount of data transmitted.

According to one or more exemplary embodiments, the number of sub-periods is at least equal to N, wherein N is the number of levels of quality.

Table 2 depicts an example of the minimum requirement depending on the sub-periods. I is the maximum level of quality and I−6 is the minimum level of quality. For example, for sub-period 3, the quality criterion required for the interval is for the level of quality to be equal to I, I−1 or I−2 so that the client device transmits a request to transmit useful data during this interval.

In the table, I is an integer in this example, but of course the information characterizing the quality can be encoded otherwise. In addition, the reduction illustrated by table 1 is of one level per sub-period, but it is possible to reduce by several levels and to reduce by a different number of levels from one sub-period to another.

TABLE 2

| Sub-period | 1 | 2 | 3 | 4 | 5 | 6 | 7 |
|---|---|---|---|---|---|---|---|
| Minimum level of quality for an | I | I-1 | I-2 | I-3 | I-4 | I-5 | I-6 |
| interval required to initiate a | | | | | | | |
| transmission during this interval | | | | | | | |

According to the embodiments, the sub-periods may have substantially equal or very different durations.

For example, if the period has a duration of six hours, then it can be divided into two sub-periods of two hours, followed by one sub-period of one hour, followed by one sub-period of 30 minutes and two sub-periods of 15 minutes. Or else, if the period has a duration of 8 hours, it can be divided into two sub-periods of three hours, followed by one sub-period of one hour, followed by two sub-periods of 30 minutes.

According to one or more embodiments, when the minimum level of quality indicated by the information is reached for a given sub-period, then this same minimum level is applied for any subsequent sub-periods, if such sub-periods exist.

For example, taking the previous example of distribution into sub-periods, which are considered to be five separate levels of quality, the highest level of quality is considered for the first sub-period, then at least the next level of quality for the next sub-period, and so on, and then the lowest level of quality will be required as of the first sub-period of 15 minutes.

According to certain embodiments, one period can be divided into intermediate periods, each of which is itself divided into sub-periods. The method described hereinbefore is then applied to each of the intermediate periods, until the client device has correctly collected the data from the server device under consideration. This makes it possible to repeat the entire method several times per period, starting with the initial requirement in terms of quality for each sub-period. The information characterizing the evolution of the level of quality of the transmission conditions over time will have been received beforehand for the entire period. For example, a day is divided into four intermediate periods of six hours, each intermediate period being divided into sub-periods according to the example given previously.

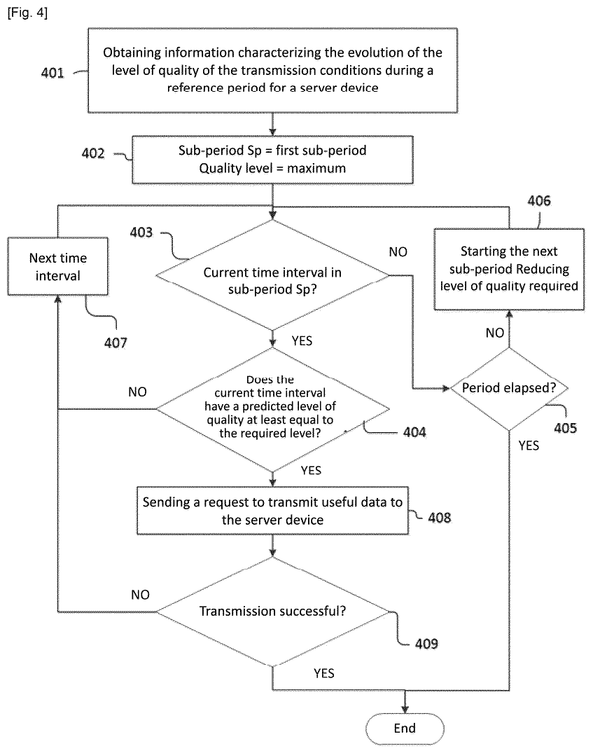

FIG. 4 is a flow chart illustrating a method implemented by a client device according to one or more exemplary embodiments. The method of FIG. 4 applies to a given server device, but can be used in parallel for several servers.

Firstly, the client device obtains the information characterizing the evolution of the level of quality of the transmission conditions during a reference period for a given server device (401).

The client device will proceed by sub-periods of the period during which they seek to obtain the transmission of useful data from the server device. For each sub-period, starting with the first (402) and with a maximum required level of quality (403), the client device will determine whether a current time interval corresponds to the required quality criterion, namely whether the level of quality predicted for this interval in the received information is at least equal to a minimum level depending on the sub-period. This verification is carried out in 404. If the verification is positive, then a request to transmit useful data is sent to the server device (408). If the data are correctly received (verification in 409), then the process ends. If the data are not correctly received, then the next interval meeting the quality criterion is awaited (407).

It is furthermore tested whether the current time interval belongs to the sub-period currently under consideration (403). If this is not the case and the entire period envisaged for the transmission has not elapsed (verification in 405), then the next sub-period starts and the required level of quality is reduced if it is not at the minimum (406). If the current interval belongs to the current sub-period, step 404 is started as disclosed in the previous paragraph.

According to the example of FIG. 4, the determination of whether a time interval meets the quality criterion is carried out in real time. However, according to other embodiments, the determination of the intervals corresponding to the criteria is carried out in advance and the result of this determination is applied when these intervals occur.

According to one or more exemplary embodiments, at the end of the period, if no transmission was able to be requested or if no data transmission could be carried out correctly, a new attempt is made during a subsequent period.

According to one or more exemplary embodiments, the client device interacts with several server devices. It is then possible to implement the method in parallel for as many server devices as necessary, with information relating to the evolution of quality specific to each server device.

According to one or more exemplary embodiments, the duration of a sub-period is adapted dynamically by advancing the start in the previous sub-period. This is possible especially when all the servers solicited during the previous period have transmitted their data successfully. Thus, the duration of a sub-period can be extended, and the level of quality required for the intervals that were previously part of the previous sub-period will be decreased, which will potentially provide more occasions for the client device to request the transmission of useful data.

According to one or more exemplary embodiments, the duration of the sub-periods for a given server device depends on the information characterizing the evolution of the level of quality over time of this server device. The client device can then adapt the duration of the sub-periods. For example, if the server device has poor transmission quality overall, the client device may provide for the final sub-periods to have a longer duration than the duration of the initial sub-periods. In the latter case, this will increase at the end of the period the number of intervals that meet the quality criterion, increasing the probability of a successful transmission of useful data.

Purely by way of illustration, a period of six hours will be divided for example into three periods of one hour, followed by two periods of 1.5 hours.

Whether a server device has good or poor transmission quality may, for example, be evaluated by comparing the average level of quality in the received information with respect to a threshold. One or more embodiments disclose a method for data transmission between a data server device (1000) and a data-receiving client device (1100) in a communication network, the server device comprising a memory (1002) including software code (1008) and a processor (1001) which, when it executes the software code, causes the server device to implement the method, the method comprising:
obtaining (201), over a first time period, a plurality of measurements characterizing a quality of transmission between the client device and the server device;
determining (202), depending on the measurements, information characterizing, over time, a relative level of quality of transmission during the first period;
transmitting (203) the information to the client device.

The method hereinbefore may further comprise receiving a data transmission request from the client device and the transmission of the data in response to the request.

### REFERENCE SIGNS

1000—Server device
1001—Processor
1002—Memory
1003—Data source
1004—Communication bus
1005—User interface
1006—Bidirectional communication interface
1007—Display
1008—Software code
1009—Working memory
1100—Client device
1101—Processor
1102—Memory
1103—Mass storage
1104—Communication bus
1105—User interface
1106—Bidirectional communication interface
1107—Display
1108—Software code
1109—Working memory

1. A method for data transmission between a data server device and a data-receiving client device in a communication network, the server device comprising a memory including software code and a processor which, when it executes the software code, causes the server device to implement the method, the method comprising:
obtaining, over a first time period, a plurality of measurements characterizing a quality of transmission between the client device and the server device;
determining, depending on the measurements, information characterizing the evolution over time of a relative level of quality of transmission during the first period;
transmitting the information to the client device;
receiving, during a second future period with respect to the first period, a data transmission request from the client device, the time of transmission of the request by the client device depending on said information transmitted by the server device to the client device; and
transmitting the data to the client device in response to the request.

2. The method of claim 1, the first period being sub-divided into time intervals, wherein determining the information comprises determining a level of quality for each interval on the basis of measurements taken for this interval with respect to one or more thresholds determined from the measurements taken over the entire first period.

3. The method according to claim 2, wherein the one or more thresholds are chosen between the highest and the lowest measurement value of the first period.

4. The method according to claim 1, wherein the determination of the information and the transmission of this information are carried out periodically.

5. The method according to claim 1, wherein the first period is one among: a time range of a day, a day.

6. The method according to claim 1, wherein the communication network is a cellular network.

7. A method for data transmission between at least one data server device and a data-receiving device in a communication network, the receiving device comprising a memory including software code and a processor which, when it executes the software code, causes the receiving device to implement the method, the method comprising:
receiving, from a given server device, information characterizing an evolution of a relative level of quality of transmission between the client device and said given server device during a first time period;
estimating the relative level of quality of transmission during a given time interval of the second period on the basis of said information corresponding to the same time interval of the first period, the time range covered by the first period including at least the time range of the second period;
deciding to send a data transmission request to the given server device during the given interval depending on the comparison of the estimation for this interval with a quality threshold.

8. The method according to claim 7, wherein the sending decision is taken as time advances during the second period, until sending results in successfully receiving said data.

9. The method according to claim 7, wherein said quality threshold depends on the placement of the given interval in the second period, the quality threshold having a maximum value at the start of the second period and decreasing as time advances in the second period toward a minimum value.

10. The method according to claim 7, wherein the second period is one among
a part of a day corresponding to the same part of the day covered by the first day during a previous day;
the day following a day covered by the second period.

11. The method according to claim 7, which comprises receiving information from a plurality of server devices, the decision to send a request to a server device depending on the information received from this server device.

12. The method according to claim 7, wherein the communication network is a cellular network.

13. A server device comprising a memory including software code and a processor which, when it executes the software code, causes the server device to implement the method according to claim 1.

14. A client device comprising a memory including software code and a processor which, when it executes the software code, causes the client device to implement the method according to claim 7.

15. A system comprising a client device according to claim 13 and at least one server device.
